(19) United States
(12) Patent Application Publication
(10) Pub. No.: US 2005/0281485 A1
(43) Pub. Date: Dec. 22, 2005

(54) Apparatus and method for efficient processing of a high resampling of a print image

(76) Inventors: Philippe Gautier, Fontenay aux Roses (FR); Richard Yvan, Paris (FR)

Correspondence Address: GLENN PATENT GROUP, 3475 EDISON WAY, SUITE L, MENLO PARK, CA, 94025, US

(21) Appl. No.: 11/144,511

(22) Filed: Jun. 2, 2005

Related U.S. Application Data
(60) Provisional application No. 60/576,296, filed on Jun. 3, 2004.

(51) Int. Cl. G06K 9/32

(52) U.S. Cl. 382/299

(57) ABSTRACT

An apparatus and method for image manipulation treatment applicable, for example, to a printing process at high resolution is discussed. The invention reduces time consumed, when high resampling image are needed, while preserving image characteristics and rendering quality. The invention enables image printing at high resolution, including images having non-continuous tone and multilevel print dithering. This is made possible because lesser amounts of significant image data are sent for computation for an equivalent to better quality of the resultant image.

### CROSS-REFERENCE TO RELATED APPLICATIONS

This application claims priority to U.S. provisional patent application Ser. No. 60/576,296 filed on 3 Jun. 2004, which application is incorporated herein its entirety by this reference thereto.

### BACKGROUND OF THE INVENTION

1. Technical Field

The invention relates generally to the manipulation of an image for the purposes of printing. More particularly, the invention relates to the reduction of compute time when high resampling of an image is required, specifically in the area of image expansion.

2. Discussion of the Prior Art

Resampling of an image usually results in a loss of image quality. This happens because pixels must either be interpolated or increased to fit the desired print area. The only exception to this is when the resolution of an image is changed without modifying the pixel dimensions. When resolution is increased without changing pixel dimensions, there is no loss of quality, but print size must be sacrificed.

Resizing an image using resampling involves changing the pixel dimensions and always introduces a loss in quality. This is because resampling uses a process called interpolation to increase the size of the image. The interpolation process estimates the values of the pixels to be created, based on the existing pixels in the image and at least some of its neighbour pixels. Resampling via interpolation results in serious blurring of the resized image, especially in areas where there are sharp lines and distinct changes in color.

Another concern is the need for a large memory space to perform resampling. This is a significant consideration when hardware accelerators are to be used. For example, consider a red-green-blue (RGB) image that is to be printed. Each component has eight-bits. If there are 3000-by-4000 pixels, there is a total of 12 Mpixels and no less than 36 Mbytes of data. In photo format of 4-inches-by-6-inches, on a printer that is capable of printing 4800*2400 dots-per-inch (DPI) there are 19200-by-14400 pixels. This must be converted from RGB to cyan-magenta-yellow-black (CMYK), which is the standard color model used in offset printing. Therefore, the final image after resampling, has a size of 36*192/30*144/40*(4/3)≅1106 Mbytes, practically over 1 GByte.

In view of the limitations of prior art solutions it would be advantageous to provide an approach that is effective in the processing time for the conversion of a RGB image to a CMYK by providing an efficient techniques for the resampling process. It would be further advantageous to enable image printing at high resolution, including images having non-continuous tone and multilevel print dithering.

### BRIEF DESCRIPTION OF THE DRAWINGS

FIG. 1 is schematic diagram showing expansion of a 1-bit image to a 4-by-8 bit image performed in accordance with the disclosed invention;

FIG. 2 is a flowchart showing the steps performed in accordance with the disclosed invention for efficient re-sampling of a print image;

FIG. 3A shows an original of a standard test image;

FIG. 3B shows a simple truncated image of the standard test image;

FIG. 3C shows an image of the standard test image after applying the disclosed algorithm

FIG. 4 is a matrix showing an exemplary C(n,m,j);

FIG. 5 is a matrix showing an exemplary S(x,y);

FIG. 6 is a matrix showing an exemplary creation of a replication/dispersion pattern;

FIG. 7 is a matrix showing an exemplary first level expansion threshold table;

FIG. 8 is a matrix showing an exemplary second level expansion threshold table;

FIG. 9 is a matrix showing an exemplary third level expansion threshold table; and

FIG. 10 shows an image processed in accordance with the disclosed invention.

### DETAILED DESCRIPTION OF THE INVENTION

In accordance with the disclosed invention there is disclosed the use of a combination expansion matrix (CEM) to achieve time-efficient resolution expansion. A CEM is comprised of N-by-M cells, that is N rows by M columns. Each cell may be associated with one or more threshold values which are a function of the desired output definition: 1 value for 1-bit, 3 for 2-bits, and 2ⁿ⁻¹ for n-bits.

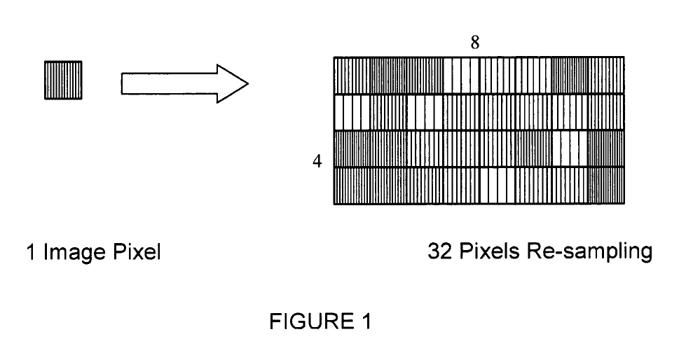

FIG. 1 shows expansion of a 1-bit image to a 4-by-8 bit image in accordance with the invention. The CEM size of 4-cells-by-8-cells can be associated to a scaling factor and, thus, each native image pixel passes through CEM 32 times. At each pass, a comparison of threshold values with each of the 32 cells results in 32 new pixels having discrete differences.

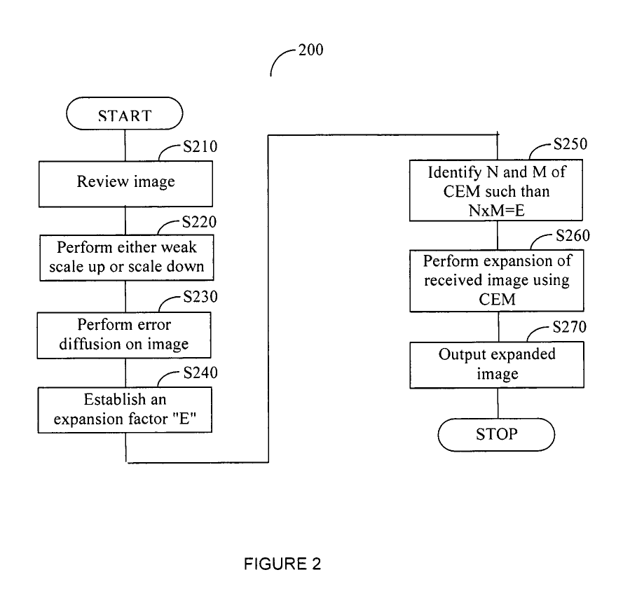

FIG. 2 shows that an input image, is received in step S210. In step S220, a weak scale-up or scale-down is performed. Resample of the native image at resolution is performed, followed by the subjecting of the scaled image to error diffusion processing, explained in more detail below in (step S230) In step S240, the expansion matrix factor E is found, which is then used for the next step. The factor E may not be a primary number because it is used to create the N*M CEM, where E=N*M, where both N and M are integers. The values of N and M are found in step S250.

As a non-limiting example, one may consider a native image having 1,000-by-1,400 pixels, in a 5-inch-by-7-inch format, which is 200 dots per inch (DPI). If it is desirable to print the image at 1,440-by-720 DPI in a 4-inch-by-6-inch format, this results in a 5,760-by-4,320 pixels on a printer with a native print head of 360 DPI. Therefore, it would be necessary to resample the image to 1,440-by-2,160 pixels in 360 DPI for a 4-inch-by-6-inch format. Hence, in one dimension a weak scale-up is made from 1,000 pixels to 1,440 and on the other dimension from 1,400 pixels to 2,160 pixels. After that, in step S260, a CEM having a size of 4-by-2, as further explained below, is used to expand the resolution to 5,760-by-4,320 pixels. The expansion factor for this example is therefore E=8. The processed image is output in step S270.

As part of the image processing, and as noted above in conjunction with step S220, a technique known as error diffusion (ED) is performed. One such technique is Floyd Steinberg error diffusion (FSED), which is commonly used for converting greyscale or continuous-tone color images into an image with 1, 2, or some other small number of bits per pixel. The fundamental principle as follows: Performed sequentially, ED traverses each pixel of the source image and is compared to a threshold. If the pixel value is higher than the threshold, a ‘1’ is output; otherwise, a ‘0’ is output. The error, i.e. the difference between the input pixel value and the output value, is dispersed to nearby neighbours. ED is a neighbourhood operation because it operates not only on the input pixel, but also impacts the pixel's neighbours. By diffusing an error to neighbours, image quality and spatial resolution are improved, compared to a simple truncation.

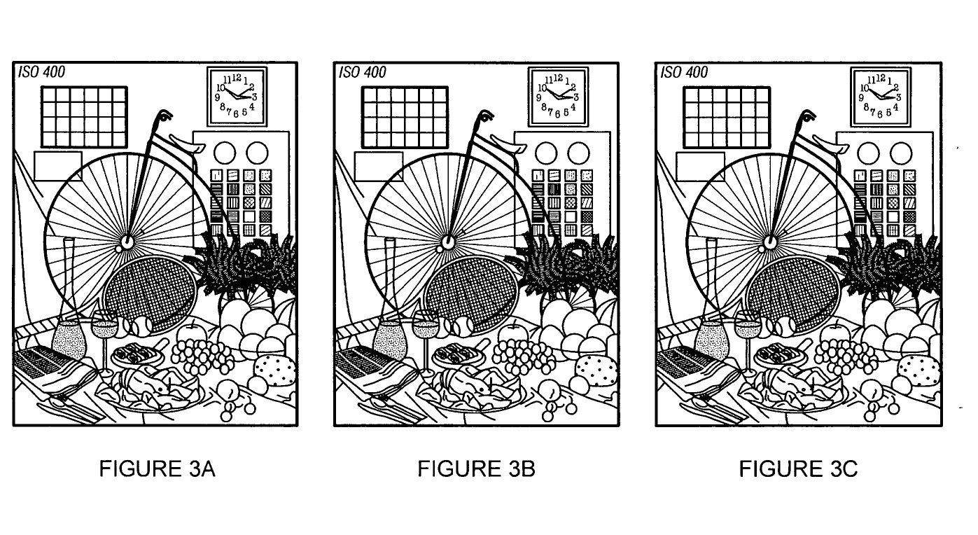

An original image is shown in FIG. 3A and a simple truncated image is shown in FIG. 3B. Prior art solutions, in particular inkjet printing processes which in most cases require in only 2-bits per color, an image is scaled to the desired output resolution and then an ED process is applied for the 2-bit output per color. In the invention, ED is performed prior to the expansion process. With ED being a time consuming process, especially when applied to a final high-resolution image, it is advantageous to perform ED first and thereby reduce the processing time required significantly. Furthermore, ED tends to create a streaking artefact, also known as worm patterns. It should be noted that blurring apparition caused by re-sampling, may increase ED patterns creation and seriously damage the image. Therefore, the application of the ED on the original image is of further advantage.

FIG. 3C shows a standard test pattern used in accordance with the invention where a classical FSED converts the original image, shown in FIG. 3A, from 8-bits to 4-bits per color. Thereafter, the expansion CEM is used on the image, instead of the prior art 8-bit to 2-bit conversion on the final image resolution. In FIG. 3C, the image dynamics and spatial resolution are kept essentially the same. The standard deviation (SD) of FIGS. 3B and 3C from FIG. 3A is 6,130 and 5,766, respectively; and the median difference value (MDV) is 7,855 and 6,581, respectively.

The operation of CEM expansion of step S260 can be further explained as a combination between halftoning by a threshold matrix and expansion by matrix re-sampling. Halftoning by a threshold matrix is known as representing grey-level images on a bi- or multi-level display device. Halftoning is a process that simulates shades of grey by varying the size of tiny black dots in a regular pattern. It relies upon the fact that the human visual system integrates information over spatial regions, so that a spatial pattern of light and dark can evoke a sensation approximating that of a uniform grey area. The bi- or multi-tonal images reproduction technique by threshold matrix includes the discretization of the function for the grey output levels reproduction. The matrix of thresholds is quadratic, rectangular or takes the shape of a parallelogram.

During image treatment, a point-by-point traversing and line-by-line-sweeping of the input image. This is performed on 256 levels of grey, as well as on the matrix of thresholds. Each intensity value is compared with the corresponding threshold value of. If the value of intensity is higher than the threshold value, the output image point is activated. Use is also made of a threshold matrix of size X*Y cells, i.e. X rows and Y columns. Each cell of the threshold matrix is associated with one or more threshold values, which are a function of the desired output definition: 1 value for 1-bit; 3 for 2-bits; and, 2ⁿ⁻¹ for n bits. A threshold matrix can be created using the Bayer Dispersion or Cluster Order method, with X and Y being less than half the expansion matrix factor E=N*M.

In accordance with the invention, instead of point-by-point traversing and line-by-line sweeping of the input image, as well as using the halftone matrix, each discrete input image pixel passes through each of the cells of an N*M CEM, and thus N*M new pixels are created. Each of the cells of the CEM is associated with one or more threshold values, being a function of the desired output definition, i.e. 1 value for 1-bit; 3 for 2-bits; and, 2ⁿ⁻¹ for n bits. The CEM size of N-by-M can be associated to a scaling factor, and thus, each native image pixels passes through the CEM N*M times, is compared with threshold values of each of the N*M cells and creates N*M new pixels having a discrete difference.

For further clarification of the invention an exemplary and non-limiting description of the creation of a CEM is now presented. For the purposes of this example, Expansion Factors E=32, N=8 and M=4 are used. Further, there is used a first Dispersed Bayer matrix of size Nc=4, where X=2 and Y=2. The CEM is multilevel, having 2-bits, which means three threshold values per cell ‘2^{n-1’}. The following definitions are used:
Nc:number of cells in the original pattern
Nr:number of replication of the original pattern, where,
   Nr=Nm*Nrm with Nrn=N/X & Nrm=M/Y
   Nr=E/Nc
( ):Current replication pattern
L:number of levels, where
   L=^{2nbits}−1
I( ):Current level
K: range Factor, where
   L=/(Nc*Nr*L) with [symbol] between 1 and 255
   K=/(E*L) in this example [symbol] =255
S(x,y):Current cell value in the original pattern
C(n,m,j):Current cell value in the CombiMatrix
There is a pre-compute of the original replication and dispersion pattern which performs the following steps:
   For X=0 to Nr−2 x+=2
   Table [x]=−Nr/2;
   For X=1 to Nr−2 x+=4
   Table [x]=Nr/4;
   For X=3 to Nr−2 x+=4
   Table [x]=5*Nr/8;
With Nr=8, the content of Table is:
   Table={−4, 2, −4, 5, −4, 2, −4}

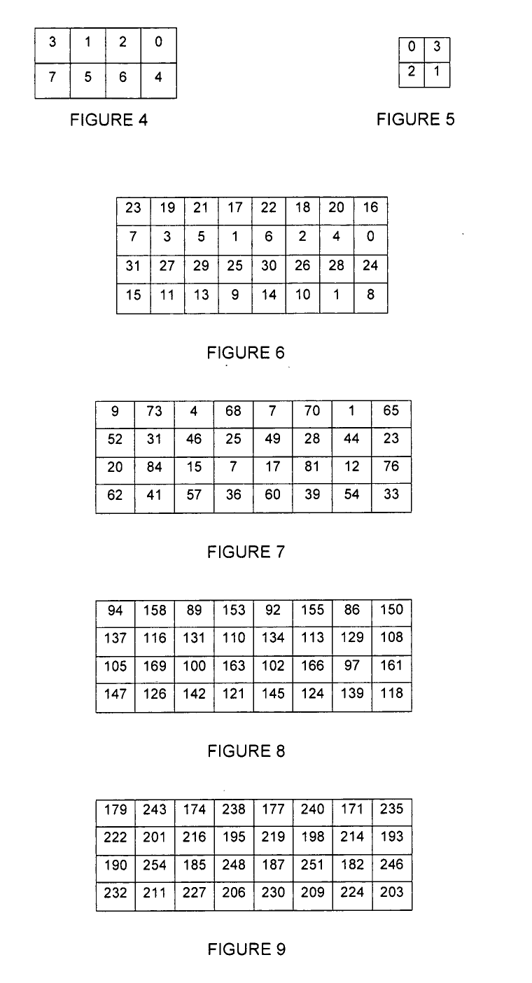

The next activity in accordance with the invention includes the step of calculating and showing of the original replication and dispersion pattern. The activity is comprised of the following steps:
NewTable[0]=Nr−1;
For X=1 to Nr−1 x+=1
NewTable[x]=NewTable [x−1]+Table [x−1];
With Nr=8, NewTable has the following values
   NewTable={7, 3, 5, 1, 6, 2, 4, 0}
As a result, with Nrn=8/2=4 and Nrm=4/2=2 that C(n,m,j) and S(x,y) has the values shown in FIGS. 4 and 5, respectively. Each of the cells of this pattern constitutes of four sub-cells representing, in this case, a dispersed Bayer matrix of size 2*2 cells. With Nr=16, Nrn=8, and Nrm=4, the Replication/dispersion Pattern shown in FIG. 6 is created.

Thereafter, the CEM is created by calculating a multilevel threshold value for each cells and sub-cell. Specifically, a multilevel threshold sub-cell determination of elementary cells can be calculated by performing the following operation:
C(n,m,j)=Round((S(n modX, m modY)*Nr+½+r(i)+Nr*Nc*l(j))*K)
Where:
   I=n divX+Nr*(m div Y)
   J from 0 to L−1
   N from 0 to N−1 & m from 0 to M−1
   Nr=8, L=3, N=8, M=4, X=2, Y=2 & Nrn=2
   r(i)=New Table[I]
   K=255*(32*3)=255/96
   The CEM can then be created by performing the following steps:
   For j=0 to L−1 j+=1
   For n=0 to N−1 n+=1
   For m=0 to M−1 m+=1
   I=n div2+8*(m div3)
   CombiMatrix[n,m]=Round((S(n modX, m modY)*Nr+½+NewTable[I]+Nr*Nc*I(j))*K)
   The respective three expansion threshold levels matrices are shown in FIGS. 7, 8, and 9, for threshold level 1, threshold level 2 and threshold level 3, respectively.

A person skilled in the art would note that the invention uses the native and universal FSED scheme to reduce definition, while trying to preserve image quality with less bits per color. Several enhancements are further possible and are hereby considered part of the invention. These include, but are not limited to, modification of the processing path by using a serpentine-like path rather than scan lines, modification of the distribution range and distribution coefficients, as well as variation of the threshold by using of an input-dependent threshold instead of a constant threshold.

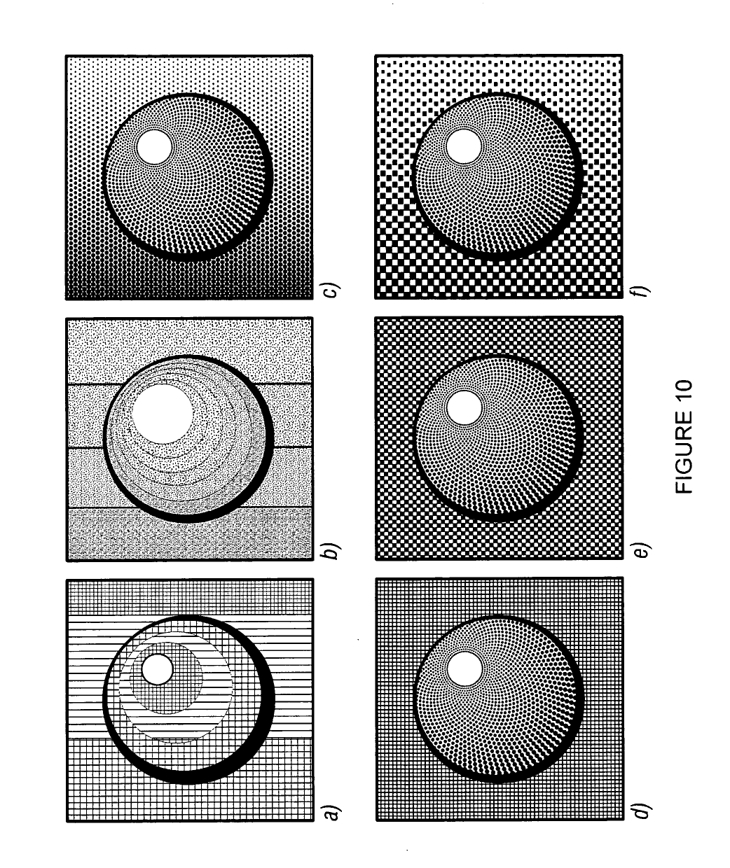

It should be noted that the CEM disperses spatial frequency of the input image and sub pixel according to an expansion factor E. A person skilled in the art would note that a regular pattern applied on a smooth image tends to create a block and banding effect. The CEM disclosed herein can be applied directly, without restriction, to improve spatial frequency dispersion. FIG. 10, shows an exemplary and non-limiting image using the invention to prevent such effect. In FIG. 10, there is shown a grey 8-bit input images, dithered with cluster order patterns of size Nc=X*Y:(a) Nc=4, (b) Nc=8, (c) Nc=18, (d) Nc=25, (e) Nc=32, and (f) Nc=50. A rotation angle is applied to disperse the threshold value in a non-regular but coherent way. Specific rotation angle is an extension of the disclosed invention, where more than one component is used to print an image without moire effect. Each component is associated with an angle of rotation to avoid ink superposition.

Accordingly, although the invention has been described in detail with reference to a particular preferred embodiment, persons possessing ordinary skill in the art to which this invention pertains will appreciate that various modifications and enhancements may be made without departing from the spirit and scope of the claims that follow.

1. A method for reducing compute time required to an input image in a higher resolution, comprising the steps of:
determining an original replication and dispersion pattern for said input image;
preparing a combination expansion matrix (CEM) by calculating multi-level threshold values; and
processing each and every input pixel of said input image with each and every cell of said CEM.

2. The method of claim 1, wherein said CEM is comprises of a number of rows and a number of columns, wherein the number of rows multiplied by the number of columns is equal to the expansion factor for said high resolution image.

3. The method of claim 1, further comprising the step of:
performing error diffusion on said input image prior to any other image processing steps.

4. The method of claim 1, further comprising the step of:
performing at least one of the steps on said input image of:
up-scaling and down-scaling.

5. The method of claim 4, in said up-scaling step comprises the conversion of the original number of pixels to a higher number of pixels, wherein when said higher number of pixel is multiplied by an integer number the result is the number of pixels of the higher resolution image.

6. The method of claim 4, wherein said down-scaling step comprises the step of:
converting of the original number of pixels to a lower number of pixels, wherein when said lower number of pixel is multiplied by an integer number the result is the number of pixels of the higher resolution image.

7. The method of claim 1, wherein said processing the step comprising the step of:
creating a two-dimensional pixel array in accordance with said CEM.

8. The method of claim 7, said processing step further comprising the step of:
comparing each input pixel with a threshold value of each of the cells of said CEM.

9. A combination expansion matrix (CEM) for reducing time a high-resolution image, said CEM comprising:
required to compute a plurality of cells organized in a number of rows and a number of columns;
wherein the number of rows multiplied by the number of columns is equal to the expansion factor for said high resolution image.

10. The CEM of claim 9, wherein each of the cells of said CEM comprises a threshold.

11. The CEM of claim 9, wherein each cell may comprises a subcell.

12. A method for scaling as image, comprising the steps of:
receiving an image;
performing an initial scale step on said image;
performing error diffusion on said image;
establishing an expansion factor E;
identifying row and column values N and M of a combination expansion matrix (CEM), wherein N×M=E;
expanding said image using said CEM; and
outputting said expansion image.

13. The method of claim 12, wherein said initial scale step is one of: weak up scale, weak down-scale.
